(19) United States
(12) Patent Application Publication
(10) Pub. No.: US 2011/0219304 A1
(43) Pub. Date: Sep. 8, 2011

(54) DICTIONARY INFORMATION DISPLAY DEVICE

(75) Inventor: Yukihiro Nakano, Ome-shi (JP)

(73) Assignee: CASIO COMPUTER CO., LTD., Tokyo (JP)

(21) Appl. No.: 13/005,663

(22) Filed: Jan. 13, 2011

(30) Foreign Application Priority Data
Mar. 5, 2010 (JP) 2010-049909

(51) Int. Cl. G06F 17/21

(52) U.S. Cl. 715/705

(57) ABSTRACT

A block data creation unit creates an explanatory assistance block data item in which an explanatory information item is placed on a word thereof in a display block of a specific size for each of the words searched for by the dictionary search unit. A block data display unit causes the display unit to display a specific number of explanatory assistance block data items created by the block data creation unit so as to correspond to an order of the words arranged in the text. A block change unit changeably displays another explanatory assistance block data item according to a user operation to the explanatory assistance block data items displayed by the block data display unit.

### CROSS-REFERENCE TO RELATED APPLICATIONS

This application is based upon and claims the benefit of priority from prior Japanese Patent Application No. 2010-049909, filed Mar. 5, 2010, the entire contents of which are incorporated herein by reference.

### BACKGROUND OF THE INVENTION

1. Field of the Invention

The present invention relates to a dictionary information display device that displays dictionary information on the words forming a sentence.

2. Description of the Related Art

For a person not fluent in a foreign language to understand a text written in the language, he or she has to look up each word in a dictionary to check its meaning and usage. However, when there are many words the user has to look up in a dictionary, a lot of time and effort are required.

To overcome the drawback, a translation support device which displays a translation of each of the words in a text (e.g., English text) beside the word to help the user understand the text has been considered as disclosed in, for example, Jpn. Pat. Appln. KOKAI Publication No. 06-325081.

Although the conventional translation support device saves the user the trouble of looking up each of the words of the text in a dictionary, a translation displayed beside each word is limited to a representative one read from the dictionary because a description space of the translation must be associated with each word.

Therefore, information is insufficient to understand the real meaning of the entire text. In addition, a great learning effect cannot be expected from just displaying a translation beside each word.

### BRIEF SUMMARY OF THE INVENTION

Accordingly, it is an object of the present invention to provide a dictionary information display device capable of effectively assisting a user in understanding or learning the real meaning of the entire displayed text.

According to one aspect of the present invention, there is provided a dictionary information display device comprising: a dictionary storage unit configured to store dictionary data in which words are associated with explanatory information items thereof; a text display unit configured to cause a display unit to display text; a dictionary search unit configured to search the dictionary data stored in the dictionary storage unit for an explanatory information item on each of the words included in the text displayed by the text display unit; a block data creation unit configured to create an explanatory assistance block data item in which an explanatory information item is placed on a word thereof in a display block of a specific size for each of the words searched for by the dictionary search unit; a block data display unit configured to cause the display unit to display a specific number of explanatory assistance block data items created by the block data creation unit so as to correspond to an order of the words arranged in the text; and a block change unit configured to changeably display another explanatory assistance block data item according to a user operation to the explanatory assistance block data items displayed by the block data display unit.

With the above structure, it is possible to effectively assist a user in understanding or learning the real meaning of the entire displayed text.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an external configuration of an electronic dictionary device 10 according to an embodiment of the invention;

FIG. 2 is a block diagram showing a configuration of the circuitry of the electronic dictionary device 10;

FIG. 3 is a flowchart to explain a dictionary assistance display process performed by the electronic dictionary device 10;

FIG. 4 is a diagram to explain the process of generating explanatory assistance blocks 51 to Bn generated according to text data specified as a result of a dictionary assistance display process at the electronic dictionary device 10;

FIGS. 5A, 5B, 5C and 5D show examples of a display operation performed in the dictionary assistance display process at the electronic dictionary device 10; and

FIGS. 6A and 6B show examples of a display operation performed in the dictionary assistance display process at the electronic dictionary device 10.

### DETAILED DESCRIPTION OF THE INVENTION

Hereinafter, referred to the accompanying drawings, an embodiment of the invention will be explained.

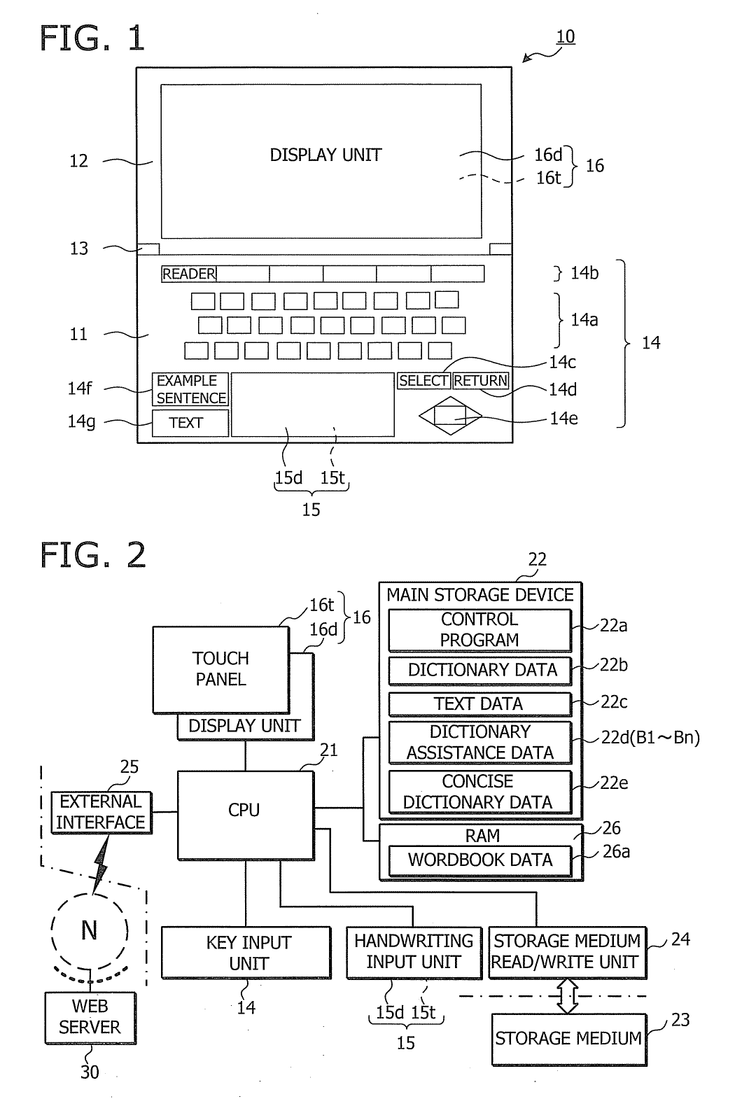

FIG. 1 is a front view showing an external configuration of an electronic dictionary device 10 according to an embodiment of the invention.

The electronic dictionary device 10 is configured as a portable device dedicated to an electronic dictionary explained below or as a personal digital assistant (PDA), a personal computer (PC), a mobile phone, an electronic book reader, a portable video game machine, or the like each of which has a dictionary function.

The electronic dictionary device 10 is so configured that a body case 11 and a cover case 12 are coupled with each other via a hinge part 13 so as to form a foldable case capable of opening and closing. At the surface of the body case 11 with the foldable case being opened, there are provided a handwriting input unit (subscreen) 15 and a key input unit (keyboard) 14 which includes character input keys 14a, dictionary specify keys 14b, “Translate/Select” key 14c, “Return” key 14d, cursor keys 14e, “Example Sentence” key 14f, and “Text” key 14g.

The handwriting input unit (subscreen) 15 has a structure where a touch position detecting device that detects a position touched by the user with a pen, a finger, or the like and a display device are integrally formed. The handwriting input unit 15 is so configured that, for example, a transparent touch panel 15t is overlaid on a 256×64 dot color liquid-crystal display screen 15d on the front side of the central part of the key input unit 14. As necessary, the input area of the handwriting input unit 15 is switched to a handwritten character input area for inputting a handwritten character, a button input area for various functions, or an area where those input areas are mixed.

A track resulting from handwriting input with the handwriting input unit 15 switched to the handwritten character input area is echoed back to the color liquid-crystal display screen 15d, which displays the track.

At the surface of the cover case 12, for example, a 480×320 dot touch panel display unit (main screen) 16 with a backlight is provided on almost all the surface. Like the handwriting input unit (subscreen) 15, the touch panel display unit (main screen) 16 has a structure where a display device and a touch position detecting device that detects a position touched by the user with a pen, a finger, or the like are integrally formed. The touch panel display unit 16 is so configured that a transparent touch panel 16t is overlaid on a color liquid-crystal display screen 16d.

FIG. 2 is a block diagram showing a configuration of the electronic circuitry of the electronic dictionary device 10.

The electronic dictionary device 10 is configured as a computer which reads programs recorded in various storage mediums and is controlled in operation by the read programs. The electronic circuitry of the computer includes a central processing unit (CPU) 21.

Using a RAM 26 as a working memory, the CPU 21 controls the operation of each of the various parts of the circuitry according to a device control program 22a prestored in a main storage device (flash ROM) 22, a device control program 22a read into the main storage device 22 from an external storage medium 23, such as a ROM card, via a storage medium read/write unit 24, or a device control program 22a read into the main storage device 22 from a Web server (in this case, a program server) 30 on the Internet via an external interface 25.

The device control program 22a stored in the main storage device 22 is activated in response to an input signal corresponding to a user operation from the key input unit 14, handwriting input unit 15, and touch panel display unit 16 or a communication signal with each Web server 30 . . . on the Internet connected via an external interface 25.

As described above, the main storage device 22, storage medium read/write unit 24, external interface 25, RAM 26, key input unit 14, handwriting input unit 15, touch panel display unit 16 are connected to the CPU 21.

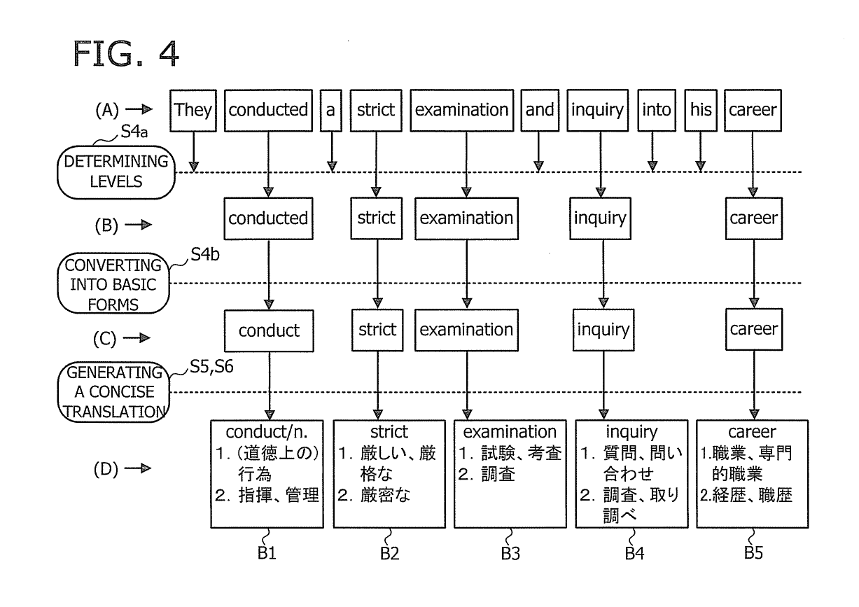

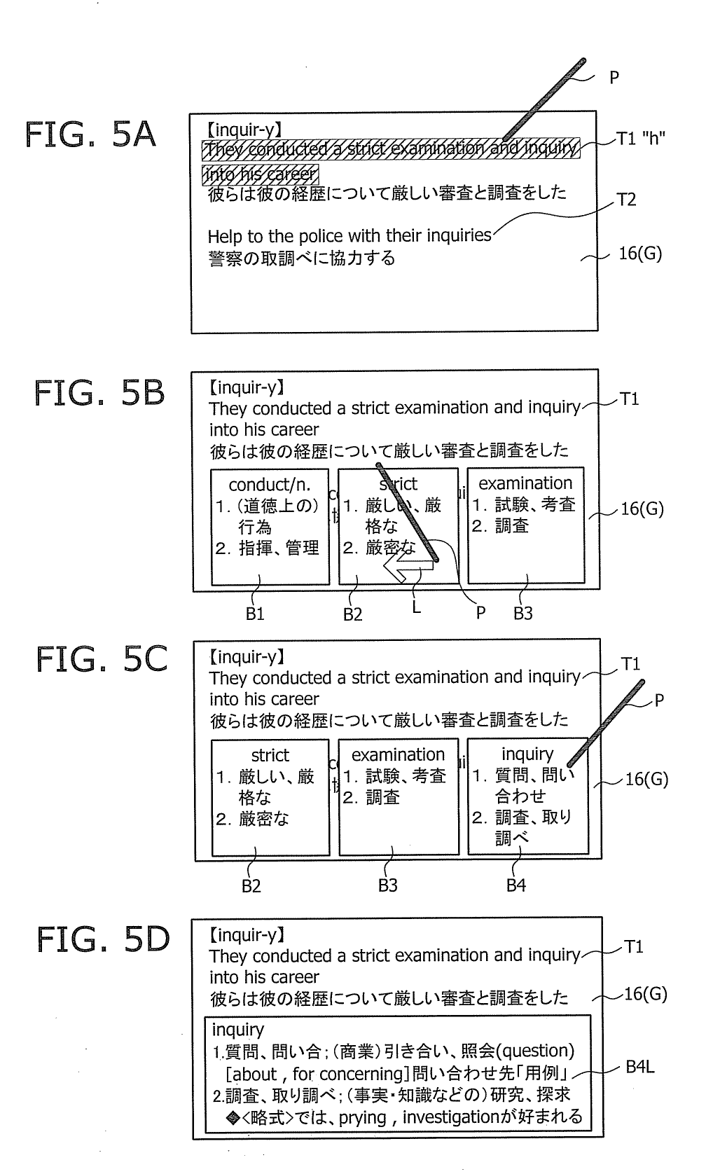

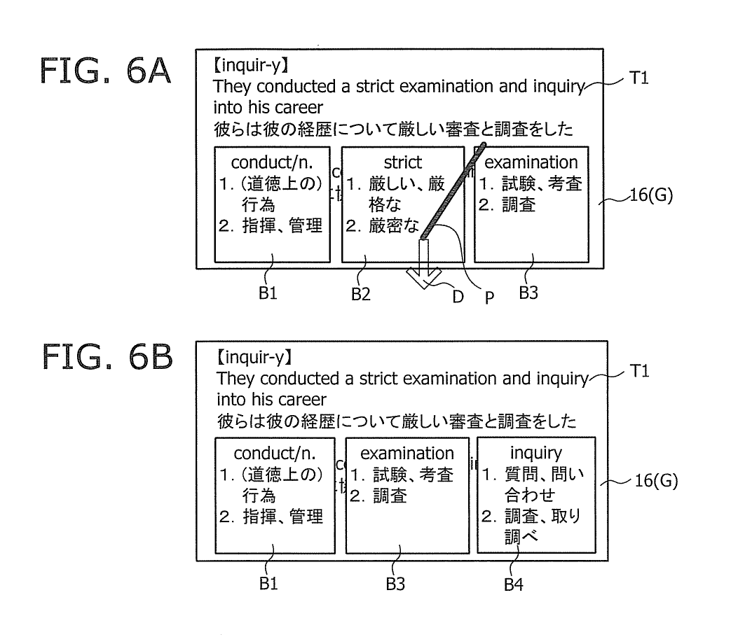

Stored as the device control program 22a in the main storage device 22 are a system program that supervises the operation of the entire electronic dictionary device 10 and a communication program for performing data communication with each Web server 30 . . . on the Internet via the external interface 25 or with a user personal computer (PC) (not shown). Further stored in the main storage device 22 are a dictionary search program for controlling an all-around search-display process on the basis of a dictionary database 22b stored in the main storage device 22, including a index word search process in a dictionary function, a list display process of search index words, a read-display process of various explanation information, including a translation, a semantic content, an example sentence (usage), corresponding to an index word focused on with cursor Cu, and a text viewer program for displaying text data in various texts read from the outside or previously stored. Still further stored in the main storage device 22 is a dictionary assistance display program for searching text data on an example sentence (usage) displayed according to the dictionary search program or text data on various sentences displayed according to the text viewer program for concise dictionary information on each of the words included in the text being displayed, generating explanatory assistance blocks B1 to Bn (see FIG. 4, FIGS. 5B and 5C, FIGS. 6A and 6B) for the respective words, and displaying the blocks in array in an arranged order of the words.

In a dictionary database 22b, for example, not only “English-Japanese dictionary” which describes Japanese explanatory information such that the information corresponds to an English index (word) and “English-English dictionary” which describes English explanatory information such that the information corresponds to an English index (word) but also various dictionary data items, including “English thesaurus,” “Japanese-English dictionary,” “Japanese-language dictionary,” and “Encyclopedia,” are stored in advance or downloaded and stored.

In addition, the main storage device 22 includes a text data memory 22c in which various text data items have been previously stored or are downloaded and stored, a dictionary assistance data memory 22d in which explanatory assistance blocks B1 to Bn generated according to the dictionary assistance display program are stored, and a concise dictionary data memory 22e in which a “Japanese-language concise dictionary” that condenses explanatory information contained in a “Japanese-language dictionary” to only main information by omitting the information in parentheses included in the explanatory information, a “Japanese-English concise dictionary” that condenses explanatory information contained in the “English-Japanese dictionary” to only main information by omitting the information in parentheses included in the explanatory information, and the like are stored such that they are caused to correspond to various dictionary data items stored in the dictionary database 22b.

The RAM 26 includes a wordbook data memory 26a in which the user can uniquely classify and register a user-desired word displayed according to the dictionary search program and a word corresponding to user-desired explanatory assistance block Bn displayed according to the dictionary assistance display program.

Next, the dictionary assistance display function of the electronic dictionary device 10 configured as described above will be explained.

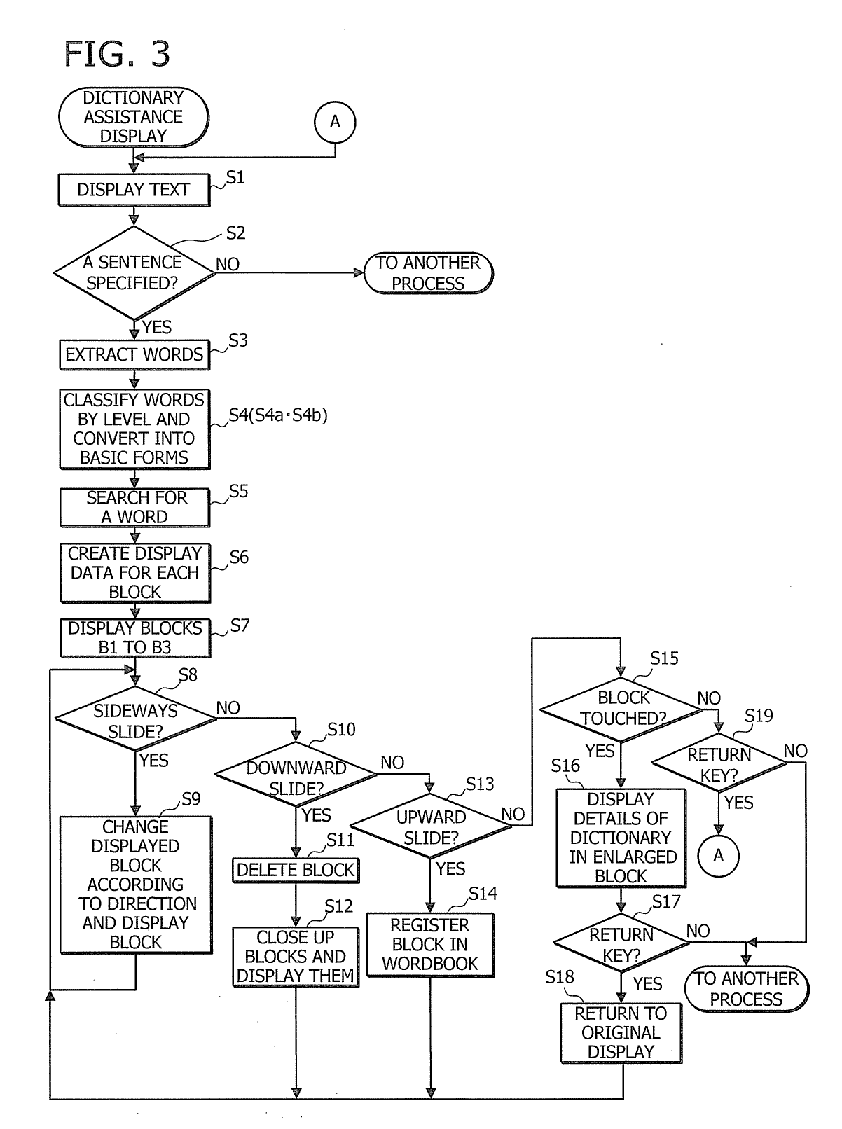

FIG. 3 is a flowchart to explain a dictionary assistance display process performed by the electronic dictionary device 10.

FIG. 4 is a diagram to explain the process of generating explanatory assistance blocks B1 to Bn generated according to text data specified as a result of a dictionary assistance display process at the electronic dictionary device 10.

FIGS. 5A, 5B, 5C, 5D, 6A and 6B show examples of a display operation performed in the dictionary assistance display process at the electronic dictionary device 10.

First, the touch panel display unit 16 of the electronic dictionary device 10 is caused to display text (step S1). For example, as shown in FIG. 5A, the user looks up (a word) “inquiry” in the “English-Japanese dictionary” in the dictionary database 22b and displays an example sentence included in its explanatory information on the touch panel display unit 16. Then, it is determined whether the user has specified a sentence (step S2). As shown in FIG. 5A, when the user has touched and specified a desired example sentence text, for example, “They conducted . . . into his career.” T1 with the pen P (Yes in step S2), all of the words included in the specified sentence are extracted (step S3).

That is, as shown in FIG. 4 (A), the words “They”, “conducted”, . . . “into”, “his” and “carrier” constituting example sentence T1 highlighted (h) on the text display screen G are extracted.

Each of the words extracted in step S3 is determined in difficulty level and importance level and classified as shown in FIGS. 4 (A)(B) (step S4a). The words “conducted”, “strict”, . . . classified as display objects are converted into the basic forms “conduct”, “strict”, . . . , respectively, on the basis of dictionary information corresponding to the respective words as shown in FIG. 4 (C) (step S4b).

Classifying words according to the difficulty level and importance level of each of the words is to exclude too easy ones of the words to the user from the display objects. For example, it is to exclude such words as an article, a particle, and the verb be from the display objects as a result of making judgments from its word class.

Then, the concise dictionary “English-Japanese concise dictionary” stored in the concise dictionary data memory 22e is searched for concise explanatory information (concise translation) using each of the words as an index word in connection with the words “conduct”, “strict”, . . . classified and converted into basic forms in step S4 (step S5). On the basis of concise explanatory information on each of the words searched for, data for displaying a concise translation in each of boxed explanatory assistance blocks B1, B2, . . . , B5 is created and stored in the dictionary assistance data memory 22d as shown in FIG. 4 (D) (step S6).

The concise dictionary is searched for a phrase included in each of the words classified and converted into basic forms in step S4 as a word and one explanatory assistance block Bn is generated.

Then, of explanatory assistance blocks B1 to B5 stored in the dictionary assistance data memory 22d, a specific number of blocks from the beginning one, for example, three blocks B1 to B3, are read and are displayed in the lower part of the text display screen G so as to be arranged in order as shown in FIG. 5B (step S7).

With the text display screen G on which explanatory assistance blocks B1 to 53 are displayed, when currently displayed arbitrary explanatory assistance block B2 is touched with the pen P and slid to the left L (Yes in step S8), currently displayed explanatory assistance blocks B1 to B3 are scrolled according to the direction in which block B2 has been slid. As shown in FIG. 5C, first explanatory assistance block B1 drops out of the display screen G to the left and is not displayed, whereas fourth explanatory assistance block B4 is newly inserted in the display screen G from the right and displayed (step S9).

Here, as shown in FIG. 5C, when explanatory assistance block B4 in which concise explanatory information (concise translation) about the word “inquiry” is contained is touched with the pen P and separated from the pen (or tapped with the pen P) (Yes in step S15), detailed explanatory information on the word “inquiry” is read from “English-Japanese dictionary” in the dictionary database 22b. Then, as shown in FIG. 5D, extended explanatory assistance block B4L in which the detailed explanatory information is contained is generated and displayed in the lower part of the display screen G in place of the three explanatory assistance blocks B2, B3, B4 currently being displayed (step S16).

Then, when the “Return” key 14d is pressed (Yes in step S17), extended explanatory assistance block B4L is deleted and control returns to a state where the text display screen G on which the three explanatory assistance blocks B2, B3, B4 have been displayed is displayed as shown in FIG. 5C (step S18).

As shown in FIG. 6A, when currently displayed arbitrary explanatory assistance block B2 has been touched with the pen P and slid downward (D) on the text display screen G on which three explanatory assistance blocks B1, B2, B3 have been displayed (Yes in step S10), explanatory assistance block B2 is deleted (step S11).

Then, as shown in FIG. 6B, explanatory assistance blocks B3, B4 following deleted explanatory assistance block B2 are displayed so as to move over to beginning explanatory assistance block S1 displayed on the left side of the display screen G (step S12).

In addition, for example, as shown in FIG. 6B, when currently displayed arbitrary explanatory assistance block B1 has been touched with the pen P and slid upward on the text display screen G on which three explanatory assistance blocks B1, B3, B4 have been displayed (Yes in step S13), the word “conduct” contained in slid explanatory assistance block B1 is registered in a wordbook of a desired class in the wordbook data memory 26a (step S14).

When the “Return” key 14d is pressed with explanatory assistance blocks B1, B2, . . . being displayed on the text display screen G (Yes in step S19), control returns to the display state of the text display screen G before explanatory assistance blocks B1, B2, . . . were displayed (step S1).

Accordingly, with the dictionary assistance display function of the electronic dictionary device 10 configured as described above, the words included in English example sentence text Tn displayed on the text display screen G are classified by difficulty level. For example, too easy words are excluded. Then, concise explanatory information (concise translation) for each of the words classified and left is retrieved from “Concise English-Japanese dictionary” (22e). Then, explanatory assistance blocks B1 to Bn each of which describes the retrieved concise explanatory information (concise translation) on each of the words are displayed together with the example sentence text Tn in the order in which the words in the text Tn are arranged.

Then, all of explanatory assistance blocks B1 to Bn for the respective words displayed in an array on the text display screen G are scrolled back and forth when an arbitrary block Bn is touched with the pen and slid along the array. In addition, when an arbitrary block Bn is touched with the pen and slid downward, the block is deleted and blocks Bn+1, Bn+2, . . . following block Bn are displayed such that they move over so as to fill the place where the deleted block Bn was. Moreover, when an arbitrary block Bn is touched with the pen and slid upward, the word contained in block Bn is registered in the wordbook (26a).

Therefore, when explanatory assistance blocks B1 to Bn where pieces of concise explanatory information on the respective words included in the English text Tn specified and displayed (h) on the text display screen G have been arranged in order are manipulated at will, this makes it possible to assist the user effectively in understanding or learning the real meaning of the entire sentence.

While in the embodiment, explanatory assistance blocks B1 to Bn for the respective words in example sentence text Tn read from the dictionary database 22b have been generated and displayed, explanatory assistance blocks B1 to Bn for the respective words in each type of text Tn read from the text data memory 22c according to the text viewer program may be generated and displayed.

In addition, while in the embodiment, word classes (article, particle, and the verb be) have been used as a difficulty level and an importance level for classifying the words extracted from the specified text Tn, the words stored in, for example, the wordbook or the search history may be classified as words of a higher importance level.

Explanatory assistance block Bn for a word stored in the wordbook or search history may be separated by color and displayed. Although a concise translation has been obtained from a concise dictionary and used as the contents of an explanatory assistance block, a concise translation may be obtained by processing dictionary information acquired by normal dictionary search and the data in the translation may be used.

In the embodiment, of a series of explanatory assistance blocks B1, B2, . . . displayed on the text display screen G, an arbitrary block Bn has been touched with the pen and slid in one or the other direction of the array of explanatory assistance blocks B1, B2, . . . , thereby scrolling explanatory assistance blocks B1, B2, . . . on the text display screen G in the direction in which block Bn was slid. In contrast, a scroll pointer may be provided on each of the right and left frames of the text display screen G and explanatory assistance blocks B1, B2, . . . displayed on the text display screen G may be scrolled in the direction pointed by the pointer when either scroll pointer is tapped.

The methods of the individual processes performed by the electronic dictionary device 10 described in the embodiment, including the method of the dictionary assistance display process explained in the flowchart of FIG. 3 and various data items (22b to 22e), can be stored in the form of a computer-executable program into external storage mediums 23, such as a memory card (e.g., a ROM card or a RAM card), a magnetic disk (e.g., a floppy disk or a hard disk), an optical disc (e.g., a CD-ROM or a DVD), or a semiconductor memory. Then, the storage mediums 23 can be delivered. The computer of an electronic device loads the program stored in the external storage medium 23 into a storage device (22). The computer is controlled by the read-in program, thereby realizing a dictionary assistance display function intended for arbitrary text data explained in the embodiment, which enables the same processes in the aforementioned methods to be carried out.

Furthermore, the data of the programs which realize the above methods can be transferred in the form of program code through a network N. The program data can be loaded by a communication control unit (25) into the computer of an electronic device connected to the network N, thereby realizing a dictionary assistance display function intended for the arbitrary text data.

As described above, according to the invention, it is possible to assist the user effectively in understanding or learning the real meaning of the displayed sentence as a whole.

This invention is not limited to the above embodiments and, on the basis of available skills in the present or future implementation phase, may be practiced or embodied in still other ways without departing from the spirit or character thereof. The embodiments include inventions of different stages and therefore various inventions can be extracted by combining suitably a plurality of structural requirements disclosed in the embodiments. For example, even if some are removed from all of the structural requirements shown in the embodiments or some of the structural requirements are combined suitably if at all possible, the resulting configuration can be extracted as an invention, provided that the subject to be achieved by the invention is accomplished and the effect of the invention is obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A dictionary information display device comprising:
a dictionary storage unit configured to store dictionary data in which words are associated with explanatory information items thereof;
a text display unit configured to cause a display unit to display text;
a dictionary search unit configured to search the dictionary data stored in the dictionary storage unit for an explanatory information item on each of the words included in the text displayed by the text display unit;
a block data creation unit configured to create an explanatory assistance block data item in which an explanatory information item is placed on a word thereof in a display block of a specific size for each of the words searched for by the dictionary search unit;
a block data display unit configured to cause the display unit to display a specific number of explanatory assistance block data items created by the block data creation unit so as to correspond to an order of the words arranged in the text; and
a block change unit configured to changeably display another explanatory assistance block data item according to a user operation to the explanatory assistance block data items displayed by the block data display unit.

2. The dictionary information display device according to claim 1, wherein the block change unit includes a block scroll unit configured to display a following explanatory assistance block data item by scrolling the explanatory assistance block data items displayed by the block data display unit in a direction corresponding to a user operation.

3. The dictionary information display device according to claim 1, wherein the block change unit includes a block delete unit configured to display a following explanatory assistance block by deleting an explanatory assistance block data item according to a user operation among the explanatory assistance block data items displayed by the block data display unit.

4. The dictionary information display device according to claim 1, further comprising a wordbook registration unit configured to register in a wordbook a word corresponding to an explanatory assistance block data item specified according to a user operation among the explanatory assistance block data items displayed by the block data display unit.

5. The dictionary information display device according to claim 1, further comprising:
a sentence specify unit configured to specify a sentence in the displayed text; and
a sorting unit configured to sort out a word to be searched for in the dictionary data from all the words constituting the sentence specified by the sentence specify unit,
wherein the dictionary search unit searches the dictionary data for the sorted word.

6. The dictionary information display device according to claim 1, further comprising a touch panel,
wherein the block change unit operates according to an operation of the touch panel.

7. The dictionary information display device according to claim 1, wherein the dictionary storage unit stores concise dictionary data including simplified contents.

8. An electronic device comprising:
a display unit;
a memory; and
a processor,
the memory storing dictionary data,
the processor performing control of:
causing a display unit to display text;
searching the dictionary data stored in the memory for an explanatory information item on each of the words included in the displayed text;
creating an explanatory assistance block data item in which an explanatory information item is placed on a word thereof in a display block of a specific size for each of the searched words;
causing the display unit to display a specific number of created explanatory assistance block data items so as to correspond to an order of the words arranged in the text; and
changeably displaying another explanatory assistance block data item according to a user operation to the displayed explanatory assistance block data items.

9. The electronic device according to claim 8, wherein the display unit includes a touch panel, and
the processor performs control to scroll and display a following explanatory assistance block data item when a user touches and slides the displayed explanatory assistance block data items in a direction in which the block data items are arranged.

10. The electronic device according to claim 8, wherein the display unit includes a touch panel, and
the processor performs control to display a following explanatory assistance block data item by deleting an explanatory assistance block data item according to a user operation in which a user touches the explanatory assistance block item among the displayed explanatory assistance block data items.

11. The electronic device according to claim 8, wherein the display unit includes a touch panel, and
the processor performs control to register a word corresponding to a touched explanatory assistance block in a wordbook according to a user operation in which a user touches the explanatory assistance block item among the displayed explanatory assistance block data items.

12. The electronic device according to claim 8, wherein the display unit includes a touch panel, and
the processor sorts out a word searched for in the dictionary data from all the words constituting a specified sentence when a user specifies a sentence in the displayed text by touching the sentence and searches the dictionary data for the sorted word.

13. The electronic device according to claim 8, wherein the dictionary data stored in the memory is concise dictionary data that includes simplified contents.

14. A dictionary information display method for use in an electronic device storing in a memory dictionary data in which words are associated with explanatory information items thereof, the method comprising:
causing a display unit to display text;
searching the dictionary data stored in the memory for an explanatory information item on each of the words included in the displayed text;
creating an explanatory assistance block data item in which an explanatory information item is placed on a word thereof in a display block of a specific size for each of the searched words;
causing the display unit to display a specific number of created explanatory assistance block data items so as to correspond to an order of the words arranged in the text; and
changeably displaying another explanatory assistance block data item according to a user operation to the displayed explanatory assistance block data items.

15. The method according to claim 14, wherein the changeably displaying includes displaying a following explanatory assistance block data item by scrolling the displayed explanatory assistance block data items in a direction corresponding to a user operation.

16. The method according to claim 14, wherein the changeably displaying includes displaying a following explanatory assistance block by deleting an explanatory assistance block data item according to a user operation among the displayed explanatory assistance block data items.

17. The method according to claim 14, further comprising:
registering in a wordbook a word corresponding to an explanatory assistance block data item specified according to a user operation among the displayed explanatory assistance blocks.

18. The method according to claim 14, further comprising:
specifying a sentence in the displayed text; and
sorting out a word to be searched for in the dictionary data from all the words constituting the specified sentence,
wherein the searching includes searching the dictionary data for the sorted word.
